(19) United States
(12) Patent Application Publication
(10) Pub. No.: US 2008/0241681 A1
(43) Pub. Date: Oct. 2, 2008

(54) Proton conducting electrolyte and electrochemical cell including proton conducting electrolyte

(75) Inventors: Naoki Ito, Yokohama-shi (JP); Hiroshige Matsumoto, Fukuoka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toyota Jidosha Kabushiki Kaisha

(21) Appl. No.: 12/073,641

(22) Filed: Mar. 7, 2008

(30) Foreign Application Priority Data
Mar. 7, 2007 (JP) 2007-056566

(51) Int. Cl. H01M 6/14

(52) U.S. Cl. 429/188

(57) ABSTRACT

A proton conducting electrolyte having good proton conductivity and an electrochemical cell that includes the proton conducting electrolyte are provided. The proton conducting electrolyte has the ABO₃ type perovskite structure, and a Site-B contains a first metal having a valence that is smaller than the average valence of the Site-B, and a second metal element having a valence that is larger than the average valence of the Site-B by at least one. Holes are formed in the proton conducting electrolyte. Thus, good proton conductivity is imparted to the proton conducting electrolyte.

### INCORPORATION BY REFERENCE

The disclosure of Japanese Patent Application No. 2007-056566 filed on Mar. 7, 2007 including the specification, drawings and abstract is incorporated herein by reference in its entirety.

### BACKGROUND OF THE INVENTION

1. Field of the Invention

The invention relates to a proton conducting electrolyte and an electrochemical cell that includes a proton conducting electrolyte.

2. Description of the Related Art

Ion conductors are used in electrochemical cells, for example, batteries, sensors, and fuel cells. Solid oxide electrolytes are one example of the ion conductors. The solid oxide electrolytes are widely used, because they have good ion conductivity. A perovskite electrolyte is one example of the solid oxide electrolytes. A perovskite electrolyte, of which the constituent elements include at least one of Chrome, Manganese, Iron, and Ruthenium, is described in, for example, PCT Publication No. 2004-074205 (WO2004-074205).

The ion conductor described in WO2004-074205 is an electron-proton mixed conductor. Therefore, there is a possibility that this ion conductor does not exhibit good proton conductivity.

### SUMMARY OF THE INVENTION

The invention provides a proton conducting electrolyte that has good proton conductivity, and an electrochemical cell that includes a proton conducting electrolyte that gas good proton conductivity.

A first aspect of the invention relates to a proton conducting electrolyte having an ABO₃ type perovskite structure. The proton conducting electrolyte includes: a Site-A; and a Site-B that contains a first metal having a valence that is smaller than the average valence of the Site-B, and a second metal element having a valence that is larger than the average valence of the Site-B by at least one. In the proton conducting electrolyte according to the first aspect of the invention, holes are formed. Thus, good proton conductivity is imparted to the proton conducting electrolyte.

The perovskite structure may be indicated by La₍₁₋ₓ₎M1ₓM2_{(1-y})M3_{y}O₃, the first metal element may be M2, and the second metal element may be M3. In this case, the proportion of the alkali earth metal constituent elements to the entire constituent elements of the proton conducting electrolyte according to the first aspect of the invention is reduced. Accordingly, the reactivity of the proton conducting electrolyte with water vapor, carbon dioxide, etc. is reduced, and therefore the stability of the proton conducting electrolyte is enhanced. The first metal element may be a bivalent metal, and the second metal element may be a pentavalent metal. In addition, M1 may be Strontium (Sr) or Barium (Ba), M2 may be Magnesium (Mg) or Scandium (Sc), and M3 may be Niobium (Nb) or Tantalum (Ta).

A second aspect of the invention relates to an electrochemical cell, including: an anode; the proton conducting electrolyte according to the first aspect of the invention, which is formed on the anode; and a cathode that is formed on the proton conducting electrolyte. In the electrochemical cell according to the second aspect of the invention, holes are formed. In this case, good proton conductivity is exhibited. Thus, good electrochemical performance is obtained.

The anode may be a hydrogen separation membrane that has hydrogen permeability. Because the proton conducting electrolyte is not a mixed ion conductor but a proton conducting electrolyte, generation of water on the anode side is suppressed. Accordingly, separation between the hydrogen separation membrane and the proton conducting electrolyte is suppressed. As described above, the second aspect of the invention exerts excellent effects especially upon fuel cells including hydrogen separation membrane.

According to the aspects of the invention described above, it is possible to obtain good proton conductivity.

### BRIEF DESCRIPTION OF THE DRAWINGS

The foregoing and further objects, features and advantages of the invention will become apparent from the following description of an example embodiment with reference to the accompanying drawings, wherein the same or corresponding portions will be denoted by the same reference numerals and wherein:

FIG. 1 is a cross-sectional view schematically showing a fuel cell according to a second embodiment of the invention;

FIG. 2 is a cross-sectional view schematically showing a hydrogen separation membrane cell according to a third embodiment of the invention;

FIG. 3 is view schematically showing a hydrogen pump according to a fourth embodiment of the invention;

FIG. 4 shows an X-ray diffraction (XRD) pattern of Sample 1-1;

FIG. 5 shows an X-ray diffraction (XRD) pattern of Sample 1-2;

FIG. 6 shows an X-ray diffraction (XRD) pattern of Sample 1-3;

FIG. 7 shows X-ray diffraction (XRD) patterns of Samples 2-1 and 2-2;

FIG. 8 shows an X-ray diffraction (XRD) pattern of Sample 2-3;

FIG. 9 shows X-ray diffraction (XRD) patterns of Samples 2-4 and 2-5;

FIG. 10 shows X-ray diffraction (XRD) patterns of Samples 3-1 and 3-2;

FIG. 11 shows X-ray diffraction (XRD) patterns of Samples 3-3, 3-4, and 3-5;

FIG. 12 shows an X-ray diffraction (XRD) pattern of Sample 4;

FIG. 13 shows graphs of electric conductivities of Samples 1-3 and 4;

FIG. 14 shows graphs of the electric conductivities of Samples 3-1, 3-2, and 3-3;

FIG. 15 shows X-ray diffraction (XRD) patterns of Samples 5-1, 5-2, 5-3, 5-4, and 5-5;

FIG. 16 shows X-ray diffraction (XRD) patterns of Samples 5-3, 5-6, and 5-7;

FIG. 17 shows X-ray diffraction (XRD) patterns of Samples 5-2, and 5-8;

FIG. 18 shows graphs of the electric conductivities of Samples 5-2, and 5-8;

FIG. 19 shows graphs of the electric conductivities of Samples 5-2, 5-3, and 5-4;

FIGS. 20 A and B show graphs of the electric conductivities of Samples 5-2, 5-3, and 5-4;

FIG. 21 shows graphs of the electric conductivities of Samples 5-3, and 5-6;

FIG. 22 shows graphs of the relationship between the electromotive force and the hydrogen partial pressure ratio at several temperatures;

FIG. 23 shows graphs of the relationship between the electromotive force and the water vapor partial pressure ratio at several temperatures;

FIG. 24 shows graphs of the relationship between the transport number and the temperature;

FIG. 25 shows X-ray diffraction (XRD) patterns of Samples 6-1, 6-2 and 6-3;

FIG. 26 shows X-ray diffraction (XRD) patterns of Samples 6-1, 6-4 and 6-5;

FIG. 27 shows graphs of the electric conductivities of Samples 6-2 and 6-4;

FIG. 28 shows infrared absorption spectrometry (IR) patterns of Samples 6-1, 6-2, and 6-3; and

FIG. 29 shows infrared absorption spectrometry (IR) patterns of Samples 6-1, 6-4, and 6-5.

### DETAILED DESCRIPTION OF EMBODIMENT

An embodiment of the invention will be described in detail with reference to the accompanying drawings.

### First Embodiment of the Invention

A proton conducting electrolyte according to a first embodiment of the invention has a perovskite structure of the ABO₃ type. In the first embodiment of the invention, a Site-B contains a first metal element and a second metal element. The valence of the first metal element is smaller than the average valence of the Site-B, and the valence of the second metal element is larger than the average valence of the Site-B by at least one. Each of the first metal element and the second metal element may contain only one type of metal, or may contain multiple types of metals. Holes are formed in the above-mentioned proton conducting electrolyte. Thus, good proton conductivity is imparted to the proton conducting electrolyte.

The average valence of a Site-A and the average valence of the Site-B are not particularly limited. For example, the average valence of the Site-A may be +2 and the average valence of the Site-B may be +4. Alternatively, the average valence of the Site-A may be +3 and the average valence of the Site-B may be +3. Further alternatively, the average valence of the Site-A may be +2.5 and the average valence of the Site-B may be +3.5. Like this, the average valence of each of the Site-A and the Site-B need not be an integral number.

The types of metals that are used to form the Site-A are not particularly limited. Examples of trivalent metals, which may be used to form the Site-A, include Lanthanum (La). The Site-A need not be made of one type of metal, and may be made of multiple types of metals. If the Site-A is made of multiple types of metals, the valences of the metals that form the Site-A may be different from each other.

For example, a bivalent metal may be used as the first metal element of the Site-B. Although the types of the bivalent metal are not particularly limited, for example, Magnesium (Mg) may be employed. For example, a trivalent metal may be used as the first metal element of the Site-B. Although the types of the trivalent metal are not particularly limited, for example, Scandium (Sc) may be employed.

For example, a tetravalent metal may be used as the second metal element of the Site-B. Although the types of the tetravalent metal are not particularly limited, for example, Zirconium (Zr), or Titanium (Ti) may be employed. Alternatively, a pentavalent metal may be used as the second metal element of the Site-B. Although the types of the pentavalent metal are not particularly limited, for example, Niobium (Nb) or Tantalum (Ta) may be employed.

Table 1 shows concrete examples of the combinations of the first metal element and the second metal element of the Site-B when Lanthanum (La) is used to form the Site-A. Note that, as shown in Table 1, a portion of the Site-A may be formed of a metal other than La, for example, Strontium (Sr), Barium (Ba), or Calcium (Ca). In Table 1, x is a value equal to or larger than 0 and smaller than 1 (0≦x≦1), and y is a value larger than 0 and smaller than 1 (0≦y≦1). In addition, a is a value equal to or larger than 0 (α≧0).

TABLE 1

| First metal | Second metal | |
|---|---|---|
| element | element | Composition formula |
| Mg | Zr | (La₍₁₋ₓ₎Srₓ)(Mg_{(1-y)}Zr_{y})O_{3-α} |
| Mg | Ti | (La₍₁₋ₓ₎Srₓ)(Mg_{(1-y)}Ti_{y})O_{3-α}, |
| | | (La₍₁₋ₓ₎Caₓ)(Mg_{(1-y)}Ti_{y})O_{3-α} |
| Mg | Nb | (La₍₁₋ₓ₎Srₓ)(Mg_{(1-y)}Nb_{y})O_{3-α}, |
| | | (La₍₁₋ₓ₎Baₓ)(Mg_{(1-y)}Nb_{y})O_{3-α} |
| Mg | Ta | La(Mg_{(1-y)}Ta_{y})O_{3-α} |
| Sc | Nb | (La₍₁₋ₓ₎Srₓ)(Sc_{(1-y)}Nb_{y})O_{3-α} |

The perovskite electrolyte that contains an alkali earth metal has a tendency to react easily with water vapor, carbon dioxide, etc. However, when a portion of the Site-A is made of a metal other than alkali earth metal, for example, when a portion of the Site-A is made of La, the proportion of the alkali earth metal portion to the entire Site-A is decreased. Accordingly, the reactivity of the perovskite electrolyte with water vapor, carbon dioxide, etc. is reduced, and therefore the stability of the perovskite electrolyte is enhanced.

### Second Embodiment of the Invention

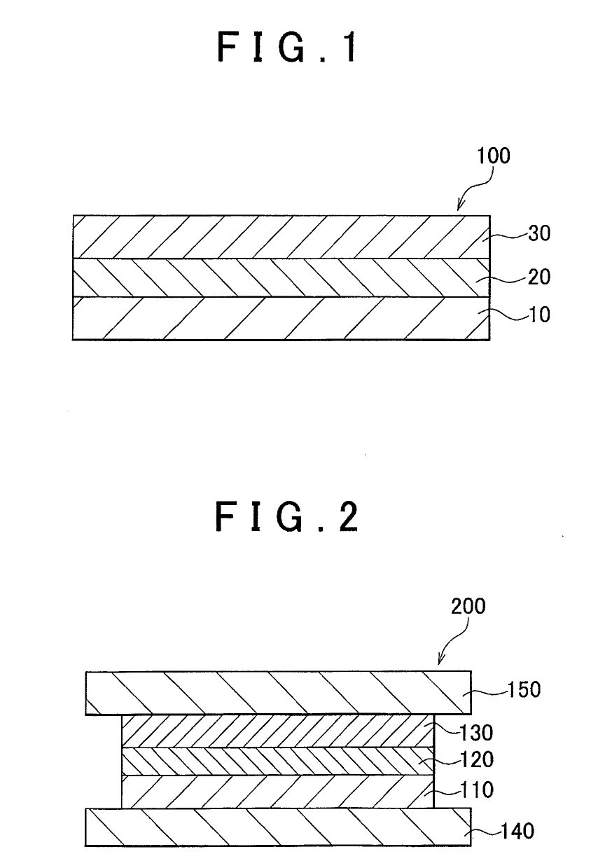

In a second embodiment of the invention, a fuel cell that includes a proton conducting electrolyte, which is an example of electrochemical cells, will be described. FIG. 1 is a cross-sectional view schematically showing a fuel cell 100 according to the second embodiment of the invention. As shown in FIG. 1, the fuel cell 100 has a structure in which an anode 10, an electrolyte membrane 20, and a cathode 30 are stacked with each other in this order. The electrolyte membrane 20 is formed of the proton conducting electrolyte according to the first embodiment of the invention.

The fuel gas that contains hydrogen is supplied to the anode 10. The hydrogen contained in the fuel gas dissociates into protons and electrons. The protons pass through the electrolyte membrane 20 and reach the cathode 30. The oxidant gas that contains oxygen is supplied to the cathode 30. The oxygen in oxidant gas and the protons that have reached the cathode 30 produce water and electricity. Using the above-described reaction, the fuel cell 100 generates electricity. In the second embodiment of the invention, because the electrolyte membrane 20 has good proton conductivity, the fuel cell 100 exhibits good power generation performance.

### Third Embodiment of the Invention

In a third embodiment of the invention, a hydrogen separation membrane cell 200, which is an example of electrochemical cells, will be described. The hydrogen separation membrane cell is one of the fuel cells, and includes a dense hydrogen separation membrane. The dense hydrogen separation membrane is a layer made of metal which has hydrogen permeability, and functions also as an anode. The hydrogen separation membrane cell has a structure in which an electrolyte that has proton conductivity is formed on the hydrogen separation membrane. The hydrogen supplied to the hydrogen separation membrane dissociates into protons and electrons. Then, the protons pass through the electrolyte that has proton conductivity, and bind with oxygen in the cathode. In this way, electricity is produced. Hereafter, the hydrogen separation membrane cell 200 will be described in detail.

FIG. 2 is a cross-sectional view schematically showing the hydrogen separation membrane cell 200. As shown in FIG. 2, the hydrogen separation membrane cell 200 has a structure in which an electricity generation portion, formed by stacking a hydrogen separation membrane 110, an electrolyte membrane 120 and a cathode 130 with each other in this order, is interposed between a separator 140 and a separator 150. In the third embodiment of the invention, the operating temperature of the hydrogen separation membrane cell 200 is within a range from 300 degrees Celsius to 600 degrees Celsius.

Each of the separators 140 and 150 is made of an electrically conducting-material, for example, stainless steel. In the separator 140, a gas passage through which the fuel gas containing hydrogen flows, is formed. In the separator 150, a gas passage through which the oxidant gas containing oxygen flows, is formed.

The hydrogen separation membrane 110 is made of a hydrogen permeating metal through which hydrogen is allowed to permeate. The hydrogen separation membrane 110 functions as an anode to which the fuel gas is supplied. In addition, the hydrogen separation membrane 110 functions as a support body to support and reinforce the electrolyte membrane 120. Examples of the metals used to form the hydrogen separation membrane 110 include Palladium (Pd), Vanadium (V), Titanium (Ti), and Tantalum (Ta). The cathode 130 is made of an electrically conducting-material, for example, La_{0.6}Sr_{0.4}CoO₃, or Sm_{0.5}Sr_{0.5}CoO₃. Note that, the material that forms the cathode 130 may carry a catalyst, for example, Platinum (Pt).

The electrolyte membrane 120 is formed of the proton conducting electrolyte according to the first embodiment of the invention. In the third embodiment of the invention, because the electrolyte membrane 120 has good proton conductivity, the hydrogen separation membrane cell 200 exhibits good power generation performance.

In order to maintain good power generation efficiency of the hydrogen separation membrane cell 200, it is necessary to keep the hydrogen separation membrane 110 and the electrolyte membrane 120 in close contact with each other. Because the electrolyte membrane 120 is not a mixed ion conductor but a proton conducting electrolyte, generation of water on the anode side is suppressed. Accordingly, using the electrolyte membrane 120 suppresses separation between the hydrogen separation membrane 110 and the electrolyte membrane 120. As described above, the electrolyte having the structure according to the invention exerts excellent effects especially upon hydrogen separation membrane cells.

### Fourth Embodiment of the Invention

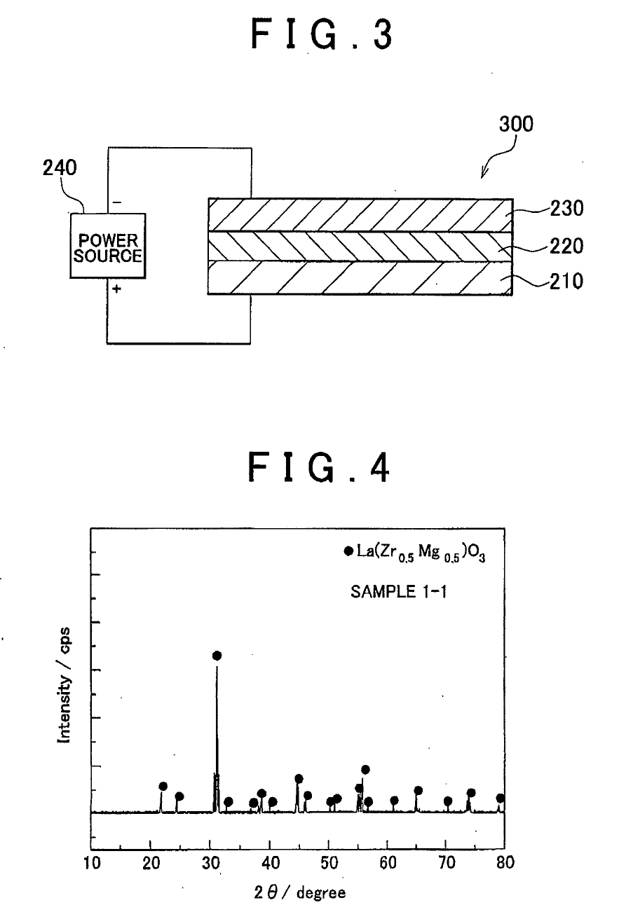

In a fourth embodiment of the invention, a hydrogen pump 300, which is an example of electrochemical cells, will be described. FIG. 3 is a view schematically showing the hydrogen pump 300. As shown in FIG. 3, the hydrogen pump 300 includes an anode 210, an electrolyte membrane 220, a cathode 230, and a power source 240. The anode 210, the electrolyte membrane 220, and the cathode 230 are stacked with each other in this order. The anode 210 is connected to the electrically positive terminal of the power source 240. Meanwhile, the cathode 230 is connected to the electrically negative terminal of the power source 240. The electrolyte membrane 220 is formed of the proton conducting electrolyte according to the first embodiment of the invention.

When a voltage is applied to each of the anode 210 and the cathode 230, hydrogen dissociates into protons and electrons. The electrons move to the power source 240. Meanwhile, the protons permeate through the electrolyte membrane 220 and reach the cathode 230. At the cathode 230, hydrogen is produced from the electrons supplied from the power source 240 and the protons. Accordingly, hydrogen is separated from the gas supplied to the anode side and moved to the cathode side by using the hydrogen pump 300. Thus, it is possible to produce hydrogen gas of high purity.

Because the electrolyte membrane 220 is formed of the proton conducting electrolyte according to the first embodiment of the invention, the electrolyte membrane 200 exhibits good proton conductivity. Accordingly, it is possible to gain good hydrogen separation efficiency.

The proton conducting electrolytes according to the first embodiment of the invention were produced, and the features thereof were examined.

### First Example

(La₍₁₋ₓ₎Srₓ)(Mg_{(1-y)}Zr_{y})O₃ series

In a first example, the proton conducting electrolytes (Samples 1-1, 1-2, and 1-3) according to the first embodiment of the invention were produced. Table 2 shows the composition formulas of Samples 1-1 to 1-3. Samples 1-1 to 1-3 were produced by sintering.

TABLE 2

| | Composition formula |
|---|---|
| Sample 1-1 | La(Mg_{0.5}Zr_{0.5})O₃ |
| Sample 1-2 | La(Mg_{0.52}Zr_{0.48})O_{3-α} |
| Sample 1-3 | (La_{0.9}Sr_{0.1})(Mg_{0.5}Zr_{0.5})O_{3-α} |

Analysis 1

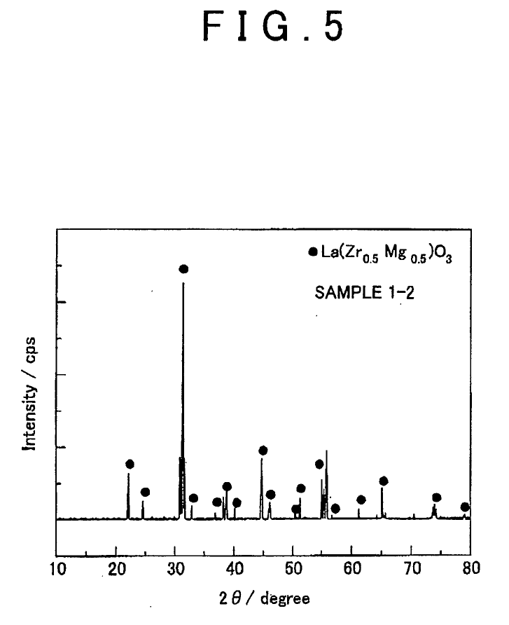

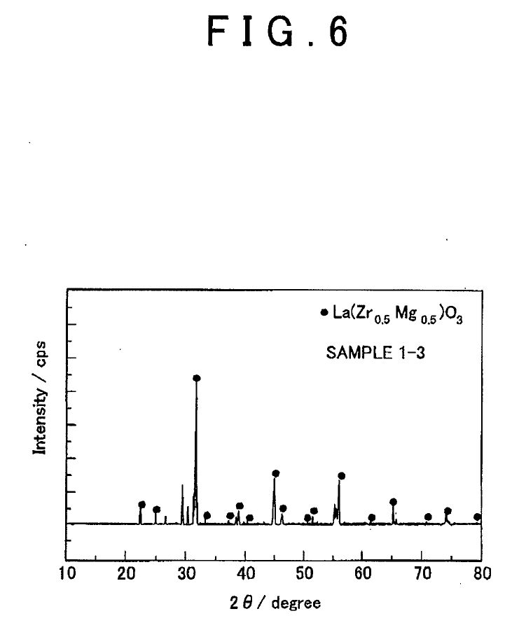

The X-ray diffraction (XRD) measurements were performed on Samples 1-1, 1-2, and 1-3. FIGS. 4, 5, and 6 show the X-ray diffraction (XRD) patterns of Samples 1-1, 1-2, and 1-3. In each of FIGS. 4, 5, and 6, the ordinate axis represents the X-ray diffraction intensity, and the abscissa axis represents the diffraction angle. As shown in FIGS. 4, 5, and 6, the diffraction peak of La(Mg_{0.5}Zr_{0.5})O₃ was detected in the diffraction pattern of each sample. Accordingly, a perovskite type proton conducting electrolyte formed of La(Mg_{0.5}Zr_{0.5})O₃ was obtained.

### Second Example

(La₍₁₋ₓ₎Srₓ)(Mg_{(1-y)}Ti_{y})O₃ series

(La₍₁₋ₓ₎Caₓ)(Mg_{(1-y)}Ti_{y})O₃ series

In a second example, the proton conducting electrolytes (Samples 2-1, 2-2, 2-3, 2-4, and 2-5) according to the first embodiment of the invention were produced. Table 3 shows the composition formulas of Samples 2-1, 2-2, 2-3, 2-4, and 2-5. Samples 2-1, 2-2, 2-3, 2-4, and 2-5 were produced by sintering.

TABLE 3

| | Composition formula |
|---|---|
| Sample 2-1 | La(Mg_{0.5}Ti_{0.5})O₃ |
| Sample 2-2 | La(Mg_{0.52}Ti_{0.48})O_{3-α} |
| Sample 2-3 | La_{0.98}(Mg_{0.5}Ti_{0.5})_{O}_{3-α} |
| Sample 2-4 | (La_{0.9}Sr_{0.1})(Mg_{0.5}Ti_{0.5})O_{3-α} |
| Sample 2-5 | (La_{0.9}Ca_{0.1})(Mg_{0.5}Ti_{0.5})O_{3-α} |

Analysis 2

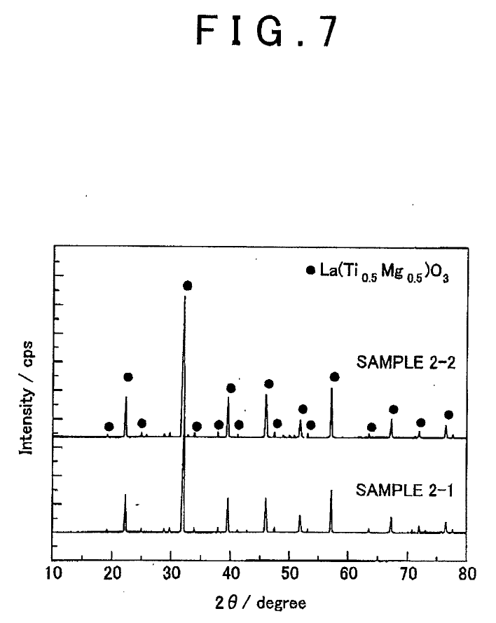

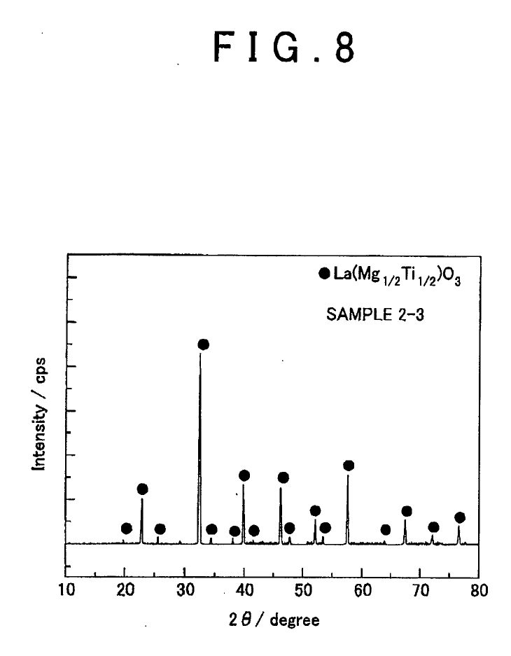

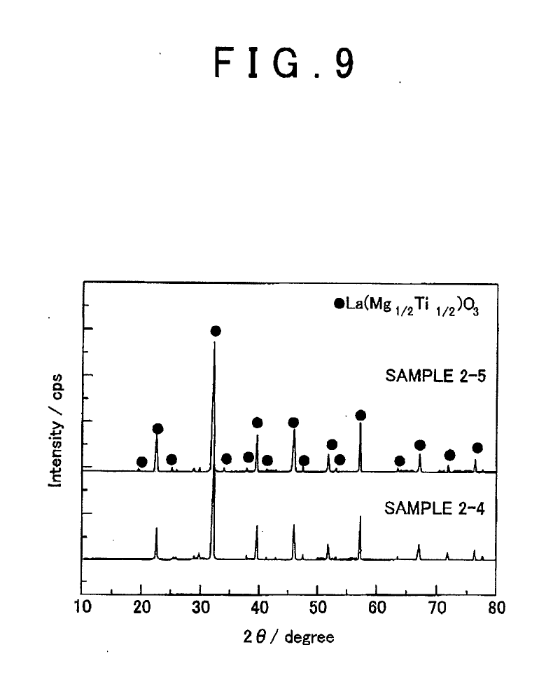

The X-ray diffraction (XRD) measurements were performed on Sample 2-1, 2-2, 2-3, 2-4, and 2-5. FIGS. 7, 8, and 9 show the X-ray diffraction (XRD) patterns of Sample 2-1, 2-2, 2-3, 2-4, and 2-5. In each of FIGS. 7, 8, and 9, the ordinate axis represents the X-ray diffraction intensity, and the abscissa axis represents the diffraction angle. As shown in FIGS. 7, 8, and 9, the diffraction peak of La(Mg_{0.5}Ti_{0.5})O₃ was detected in the diffraction pattern of each sample. Accordingly, a perovskite type proton conducting electrolyte formed of La(Mg_{0.5}Ti_{0.5})O₃ was obtained.

### Third Example

(La₍₁₋ₓ₎Srₓ)(Mg_{(1-y)}Nb_{y})O₃ series

(La₍₁₋ₓ₎Baₓ)(Mg_{(1-y)}Nb_{y})O₃ series

In a third example, the proton conducting electrolytes (Samples 3-1, 3-2, 3-3, 3-4, and 3-5) according to the first embodiment of the invention were produced. Table 4 shows the composition formulas of Samples 3-1, 3-2, 3-3, 3-4, and 3-5. Samples 3-1, 3-2, 3-3, 3-4, and 3-5 were produced by sintering.

TABLE 4

| | Composition formula |
|---|---|
| Sample 3-1 | La(Mg_{0.68}Nb_{0.32})O_{3-α} |
| Sample 3-2 | La(Mg_{0.7}Nb_{0.3})O_{3-α} |
| Sample 3-3 | (La_{0.95}Sr_{0.05})(Mg_{2/3}Nb_{1/3})O_{3-α} |
| Sample 3-4 | (La_{0.9}Sr_{0.1})(Mg_{2/3}Nb_{1/3})O_{3-α} |
| Sample 3-5 | (La_{0.8}Sr_{0.2})(Mg_{2/3}Nb_{1/3})O_{3-α} |

Analysis 3

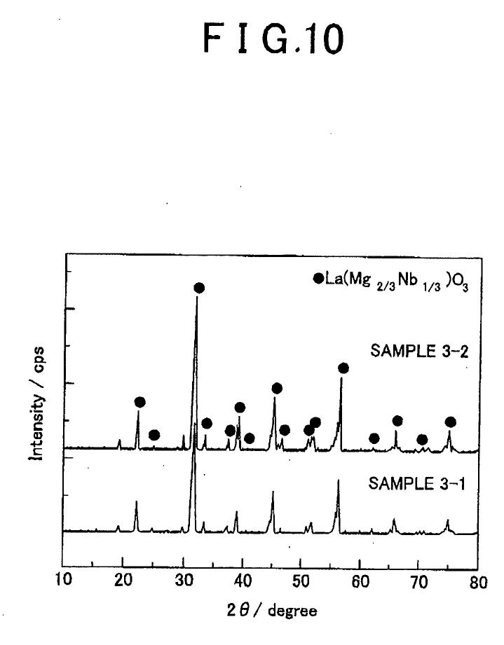

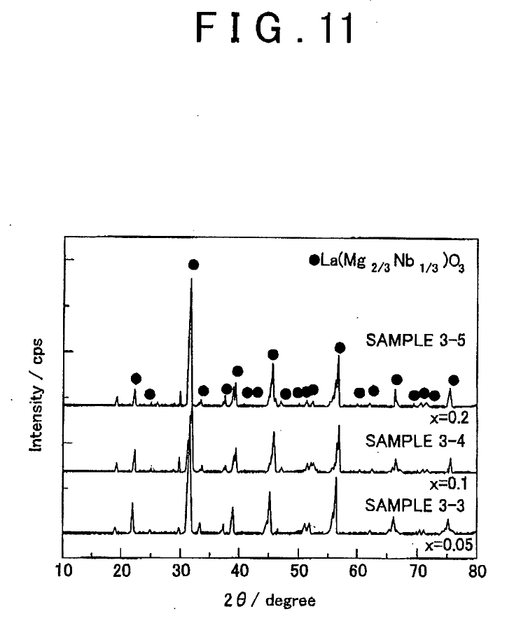

The X-ray diffraction (XRD) measurements were performed on Sample 3-1, 3-2, 3-3, 3-4, and 3-5. FIGS. 10 and 11 show the X-ray diffraction (XRD) patterns of Sample 3-1, 3-2, 3-3, 3-4, and 3-5. In each of FIGS. 10 and 11, the ordinate axis represents the X-ray diffraction intensity, and the abscissa axis represents the diffraction angle. As shown in FIGS. 10 and 11, the diffraction peak of La(Mg_{2/3}Nb_{1/3})O₃ was detected in the diffraction pattern of each sample. Accordingly, a perovskite type proton conducting electrolyte formed of La(Mg_{2/3}Nb_{1/3})O₃ was obtained.

### Fourth Example

La(Mg_{(1-y)}Ta_{y})O₃ series

In a fourth example, the proton conducting electrolyte (Sample 4) according to the first embodiment of the invention was produced. The composition of Sample 4 is La(Mg_{0.68}Ta_{0.32})O_{3-α}. Sample 4 was produced by sintering.

Analysis 4

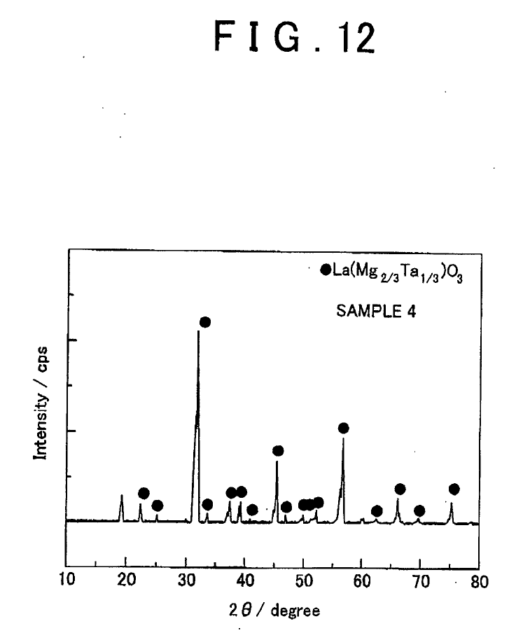

The X-ray diffraction (XRD) measurement was performed on Sample 4. FIG. 12 shows the X-ray diffraction (XRD) pattern of Sample 4. In FIG. 12, the ordinate axis represents the X-ray diffraction intensity, and the abscissa axis represents the diffraction angle. As shown in FIG. 12, the diffraction peak of La(Mg_{2/3}Ta_{1/3})O₃ was detected in the diffraction pattern of Sample 4. Accordingly, a perovskite type proton conducting electrolyte formed of La(Mg_{2/3}Ta_{1/3})O₃ was obtained.

Analysis 5

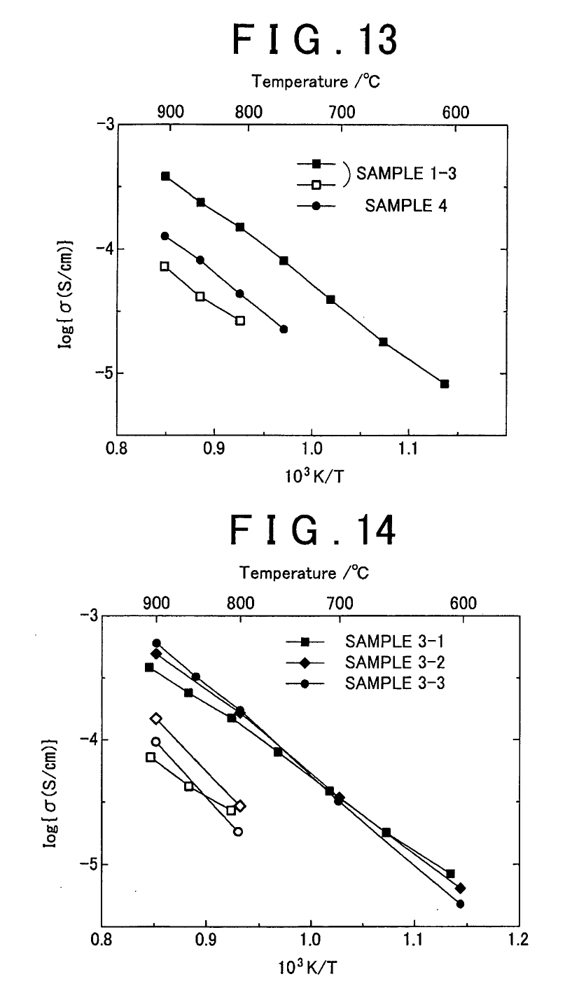

The electric conductivity of each of Samples 3-1, 3-2, 3-3, and 4 was measured. FIG. 13 shows the electric conductivities of Samples 3-1 and 4. FIG. 14 shows the electric conductivities of Samples 3-1, 3-2, and 3-3. In each of FIGS. 13 and 14, the ordinate axis represents the logarithm of the electric conductivity (S/cm), and the abscissa axis represents the inverse number of the absolute temperature (1/K). In FIGS. 13 and 14, hollow symbols show the electric conductivities of the samples in wet hydrogen, and solid symbols show the electric conductivities of the samples in wet oxygen.

As shown in FIG. 13 and FIG. 14, each of Samples 3-1, 3-2, 3-3 and Sample 4 exhibited good electric conductivity. The sample that contains Niobium exhibited better electric conductivity than that of the sample that contains Tantalum. Because Samples 3-1, 3-2, 3-3, and 4 are just examples, the composition ratios are not limited to those of these samples. It is expected that, even if electric conductivities of samples, which contain the constituent elements at composition ratios different from those of Samples 3-1, 3-2, 3-3, and 4, are measured, similar results will be obtained.

### Fifth Example

(La₍₁₋ₓ₎Srₓ)(Mg_{(1-y)}Nb_{y})O₃ series

(La₍₁₋ₓ₎Baₓ)(Mg_{(1-y)}Nb_{y})O₃ series

In a fifth example, the proton conducting electrolytes (Sample 5-1, 5-2, 5-3, 5-4, 5-5, 5-6, 5-7, and 5-8) according to the first embodiment of the invention were produced. Table 5 shows the composition formulas of Sample 5-1, 5-2, 5-3, 5-4, 5-5, 5-6, 5-7, and 5-8. Sample 5-1, 5-2, 5-3, 5-4, 5-5, 5-6, 5-7, and 5-8 were produced by sintering.

TABLE 5

| | Composition formula | x | y |
|---|---|---|---|
| Sample 5-1 | (La_{1/2-x}Sr_{1/2+x})(Mg_{1/2+y}Nb_{1/2-y})O_{3-α} | 0 | 0 |
| Sample 5-2 | | | 0.02 |
| Sample 5-3 | | | 0.04 |
| Sample 5-4 | | | 0.06 |
| Sample 5-5 | | | 0.08 |
| Sample 5-6 | | 0.05 | 0.04 |
| Sample 5-7 | | 0.1 | |
| Sample 5-8 | (La_{1/2-x}Ba_{1/2+x})(Mg_{1/2+y}Nb_{1/2-y})O_{3-α} | 0 | 0.02 |

Analysis 6

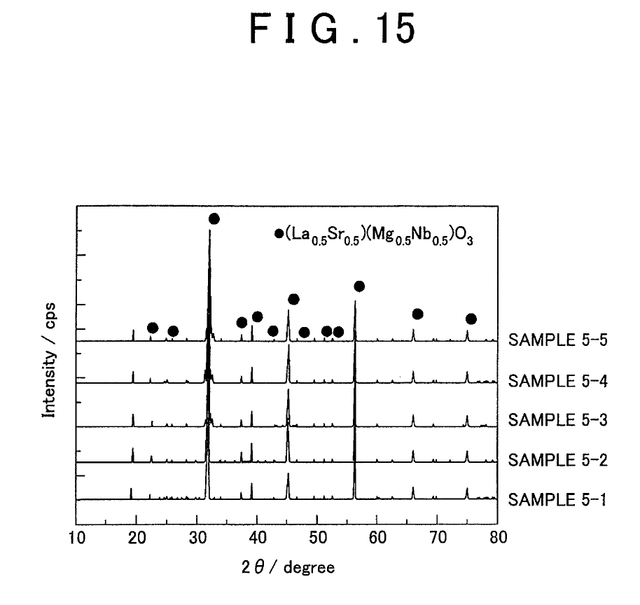

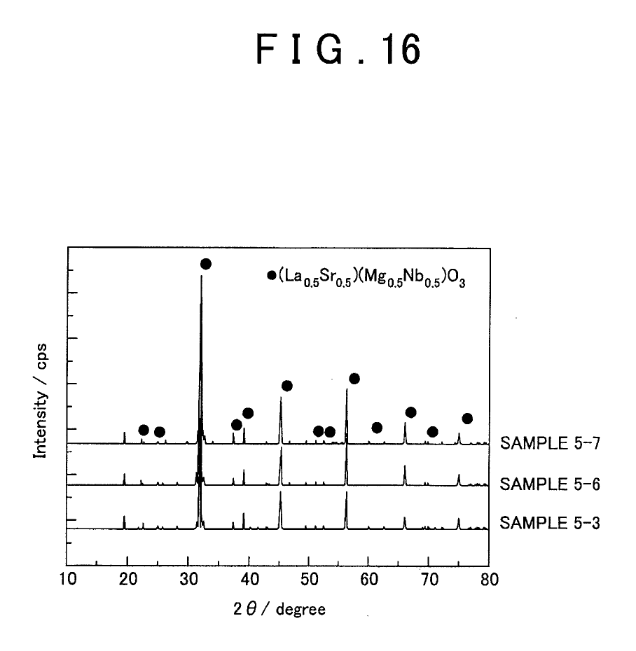

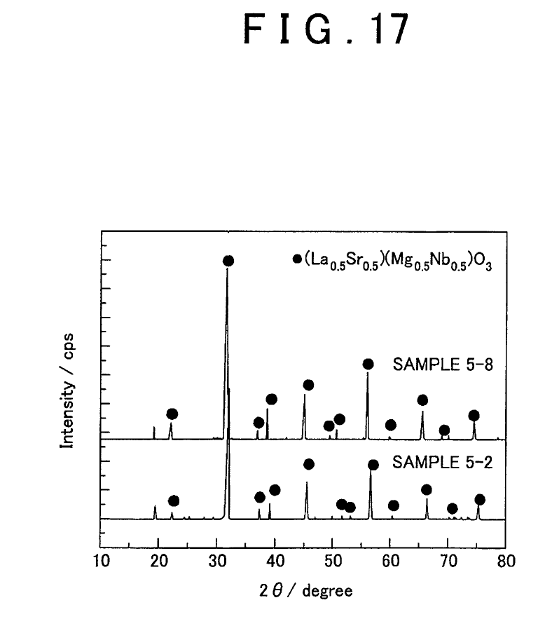

The X-ray diffraction (XRD) measurements were performed on Samples 5-1, 5-2, 5-3, 5-4, 5-5, 5-6, 5-7, and 5-8. FIGS. 15, 16, and 17 show the X-ray diffraction (XRD) patterns of Samples 5-1, 5-2, 5-3, 5-4, 5-5, 5-6, 5-7, and 5-8. In each of FIGS. 15, 16, and 17, the ordinate axis represents the X-ray diffraction intensity, and the abscissa axis represents the diffraction angle. As shown in FIGS. 15, 16, and 17, the diffraction peak of (La_{0.5}Sr_{0.5})(Mg_{0.5}Nb_{0.5})O₃ was detected in the diffraction pattern of each sample. Accordingly, a perovskite type proton conducting electrolyte formed of (La_{0.5}Sr_{0.5})(Mg_{0.5}Nb_{0.5})O₃ was obtained.

Analysis 7

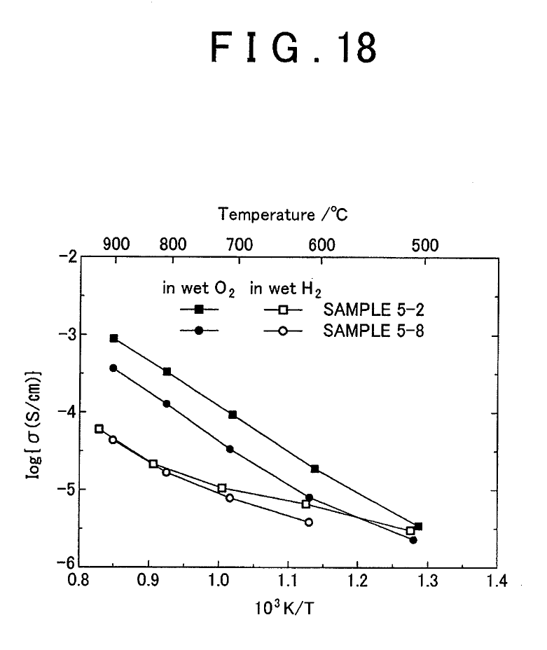

The electric conductivities of Samples 5-1, 5-2, 5-3, 5-4, 5-5, 5-6, 5-7, and 5-8 were measured. FIG. 18 shows the electric conductivities of Samples 5-2 and 5-8. In FIG. 18, the ordinate axis represents the logarithm of the electric conductivity (S/cm), and the abscissa axis represents the inverse number of the absolute temperature (1/K). In FIG. 18, hollow symbols show the electric conductivities of the samples in wet hydrogen, and solid symbols show the electric conductivities of the samples in wet oxygen. As shown in FIG. 18, each of Samples 5-2 and 5-8 exhibited good electric conductivity.

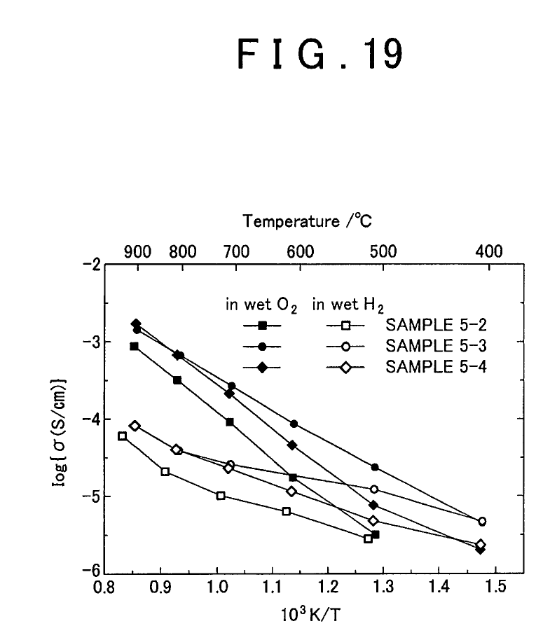

FIG. 19 shows the electric conductivities of Samples 5-2, 5-3, and 5-4. In FIG. 19, the ordinate axis represents the logarithim of the electric conductivity (S/cm), and the abscissa axis represents the inverse number of the absolute temperature (1/K). In FIG. 19, hollow symbols show the electric conductivities of the samples in wet hydrogen, and solid symbols show the electric conductivities of the samples in wet oxygen. As shown in FIG. 19, when the value of y was 0.04, the highest electric conductivity was exhibited.

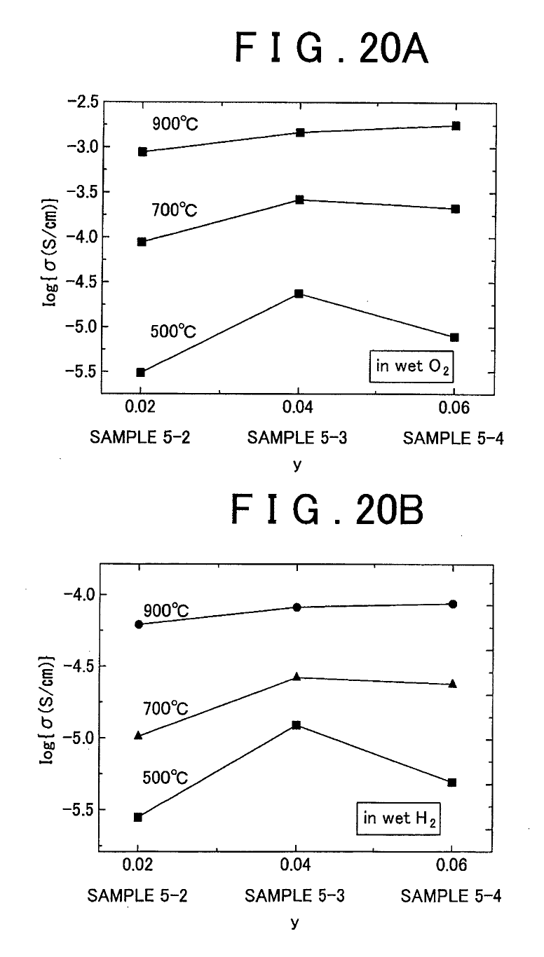

Next, the electric conductivity of each sample was measured using the temperature and the Magnesium (Mg) content as parameters. FIG. 20A shows the electric conductivities of Samples 5-2, 5-3, and 5-4 in wet oxygen. FIG. 20B shows the electric conductivities of Samples 5-2, 5-3, and 5-4 in wet hydrogen. In each of FIGS. 20A and 20B, the ordinate axis represents the logarithm of the electric conductivity (S/cm), and the abscissa axis represents the inverse number of the absolute temperature (1/K). As shown in the FIGS. 20A and 20B, when the value of y was 0.04, the highest electric conductivity was exhibited at each temperature. Accordingly, it was found that the perovskite of LaSrMgNbO₃ series exhibits the highest electric conductivity when the value of y is around 0.04.

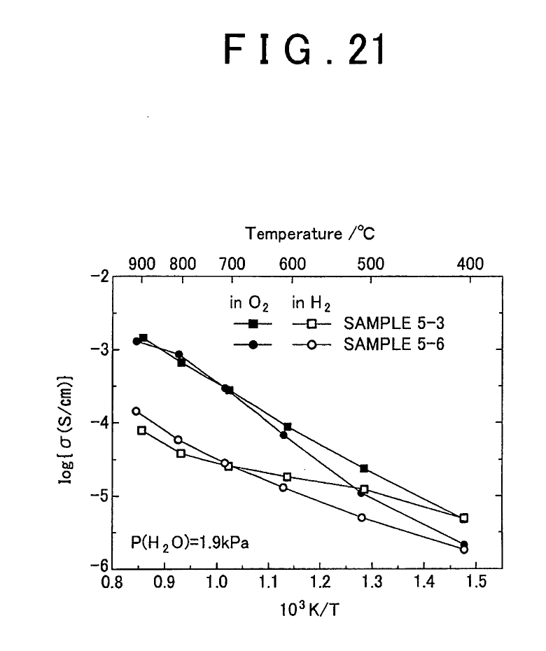

Next, the electric conductivity of each sample was measured using the composition ratio of the constituent elements of Site-A as a parameter. FIG. 21 shows the electric conductivities of Samples 5-3 and 5-6. In FIG. 21, the ordinate axis represents the logarithm of the electric conductivity (S/cm), and the abscissa axis represents the inverse number of the absolute temperature (1/K). In FIG. 21, hollow symbols show the electric conductivities of the samples in wet hydrogen, and solid symbols show the electric conductivities of the samples in wet oxygen. As shown in FIG. 21, a great influence was not exerted on the perovskite of LaSrMgNbO₃ series even if the composition ratio of the constituent elements of the Site-A was changed.

Analysis 8

The electromotive force of a hydrogen concentration cell formed using Sample 5-3 was measured. Table 6 shows the hydrogen concentrations in the gases and the flow rate of the gases, which were used for measurements. Note that, the humidification temperature of each of Gas 1 and Gas 2 was set to 17 degrees Celsius. Accordingly, the partial pressure of water vapor contained in the Gas 1 and the partial pressure of water vapor in Gas 2 were substantially equal to each other. Gas 1 was supplied to one of the electrodes of the hydrogen concentration cell and Gas 2 was supplied to the other electrode of the hydrogen concentration cell. The temperatures were set to 500, 600, 700, 800 and 900 degrees Celsius.

TABLE 6

| Gas 1 | Gas 2 |
|---|---|
| 1% H₂ 100 cc/min | 1% H₂ 30 cc/min |
| 100% H₂ 5 cc/min + Ar 95 cc/min | 1% H₂ 30 cc/min |
| 100% H₂ 25 cc/min + Ar 75 cc/min | 1% H₂ 30 cc/min |
| 100% H₂ 50 cc/min + Ar 50 cc/min | 1% H₂ 30 cc/min |
| 100% H₂ 75 cc/min + Ar 25 cc/min | 1% H₂ 30 cc/min |
| 100% H₂ 100 cc/min | 1% H₂ 30 cc/min |

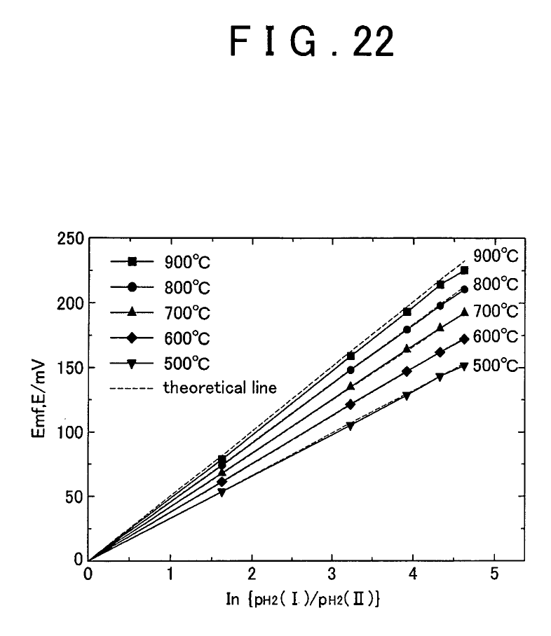

FIG. 22 shows the relationship between the electromotive force and the hydrogen partial pressure ratio at the each temperature. In FIG. 22, the ordinate axis represents the electromotive force, and the abscissa axis represents the ratio of the partial pressure of hydrogen in Gas 1 to the partial pressure of hydrogen in Gas 2. As shown in FIG. 22, in the hydrogen concentration cell, the measured electromotive force was substantially equal to the theoretical value of the electromotive force at each temperature.

In addition, the electromotive force of the hydrogen concentration cell formed using Sample 5-3 was measured. Table 7 shows the humidification temperatures for Gas 3 and Gas 4 used for measurements. The hydrogen concentration in each of Gas 3 and Gas 4 was set to 1%. Accordingly, the partial pressure of hydrogen in Gas 3 and the partial pressure of hydrogen in Gas 4 were substantially equal to each other. Gas 3 was supplied to one of the electrodes of the hydrogen concentration cell and Gas 4 was supplied to the other electrode of the hydrogen concentration cell. The temperatures were set to 500, 600, 700, 800 and 900 degrees Celsius.

TABLE 7

| Bubbler Gas 3 | Bubbler Gas 4 |
|---|---|
| 5° C. | 20° C. |
| 10° C. | 20° C. |
| 15° C. | 20° C. |
| 20° C. | 20° C. |

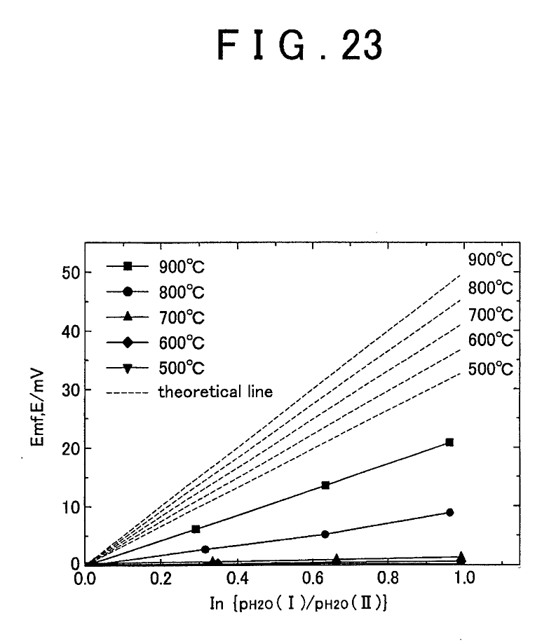

FIG. 23 shows the relationship between the electromotive force and the partial pressure of hydrogen at the each temperature. In FIG. 23, the ordinate axis represents the electromotive force, and the abscissa axis represents the ratio of the partial pressure of hydrogen in Gas 3 to the partial pressure of hydrogen in Gas 4. As shown in FIG. 23, the measured electromotive force was substantially equal to zero at the temperatures equal to and below 700 degrees Celsius.

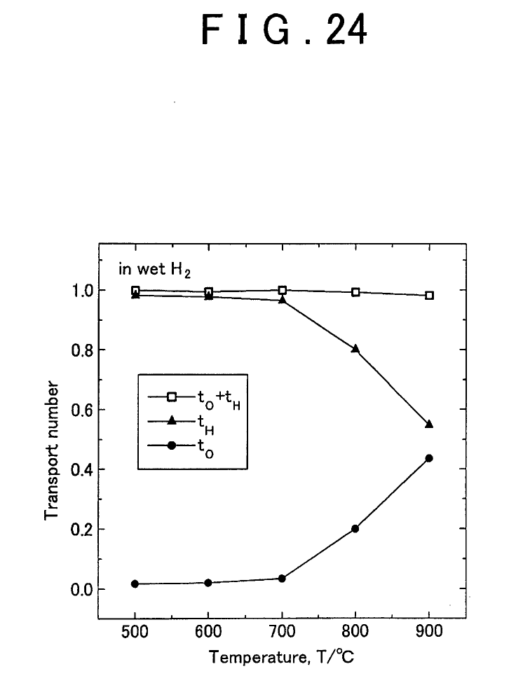

Based on the result of these measurements, the relationship between the temperature and the transport number was obtained. FIG. 24 shows the relationship between the temperature and the transport number in Sample 5-3. In FIG. 24, the ordinate axis represents the transport number of each movable element, and the abscissa axis represents the temperature. The transport number of oxygen ion is indicated by to, and the transport number of proton is indicated by t_{H}. As shown in FIG. 24, the transport number of proton was substantially equal to 1 at the temperatures equal to and below 700 degrees Celsius. It is estimated that the transport number of proton will be substantially equal to 1 at the temperatures below 500 degrees Celsius. Accordingly, it turned out that the electrolyte of Sample 5-3 has good proton conductivity. In addition, it is estimated that the other samples in the fifth example will exhibit similar measurement results. Furthermore, it is estimated that the samples in the other examples will exhibit similar measurement results.

### Sixth Example

(La₍₁₋ₓ₎Srₓ)(Sc_{(1-y)}Nb_{y})O₃ series

In a sixth example, the proton conducting electrolytes (Sample 6-1, 6-2, 6-3, 6-4, and 6-5) according to the first embodiment of the invention were produced. Table 8 shows the composition formulas of Sample 6-1, 6-2, 6-3, 6-4, and 6-5.

TABLE 8

| | Composition formula | x | y |
|---|---|---|---|
| Sample 6-1 | (La_{1/2-x}Sr_{1/2+x})(Sc_{3/4+y}Nb_{1/4-y})O_{3-α} | 0 | 0 |
| Sample 6-2 | | | 0.03 |
| Sample 6-3 | | | 0.05 |
| Sample 6-4 | | 0.05 | 0 |
| Sample 6-5 | | 0.1 | |

Analysis 9

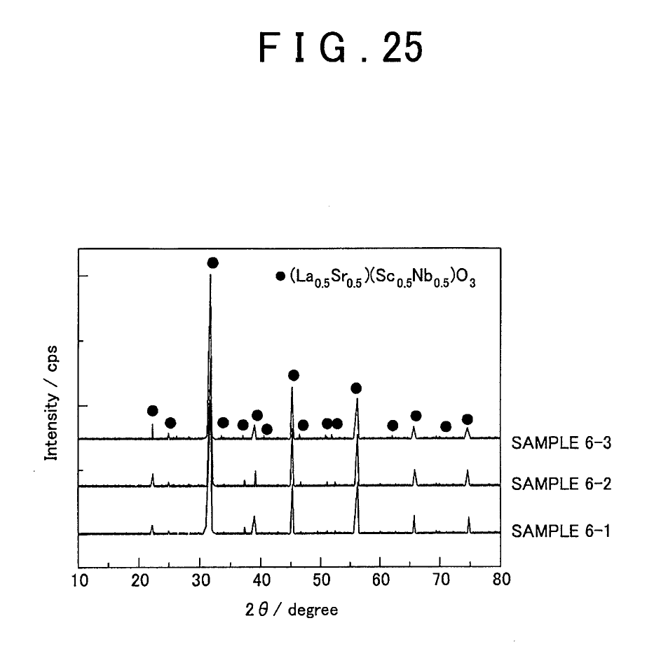

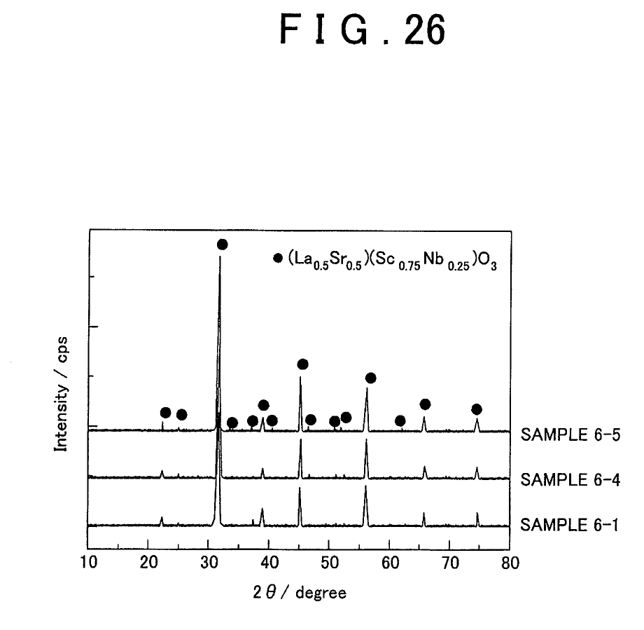

The X-ray diffraction (XRD) measurements were performed on Sample 6-1, 6-2, 6-3, 6-4, and 6-5. FIGS. 25 and 26 show the X-ray diffraction (XRD) patterns of Sample 6-1, 6-2, 6-3, 6-4, and 6-5. In each of FIGS. 25 and 26, the ordinate axis represents the X-ray diffraction intensity, and the abscissa axis represents the diffraction angle. As shown in FIGS. 25 and 26, the diffraction peak of (La_{0.5}Sr_{0.5})(Sc_{0.75}Nb_{0.25})O₃ was detected in the diffraction pattern of each sample. Accordingly, a perovskite type proton conducting electrolyte formed of (La_{0.5}Sr_{0.5})(Sc_{0.75}Nb_{0.25})O₃ was obtained.

Analysis 10

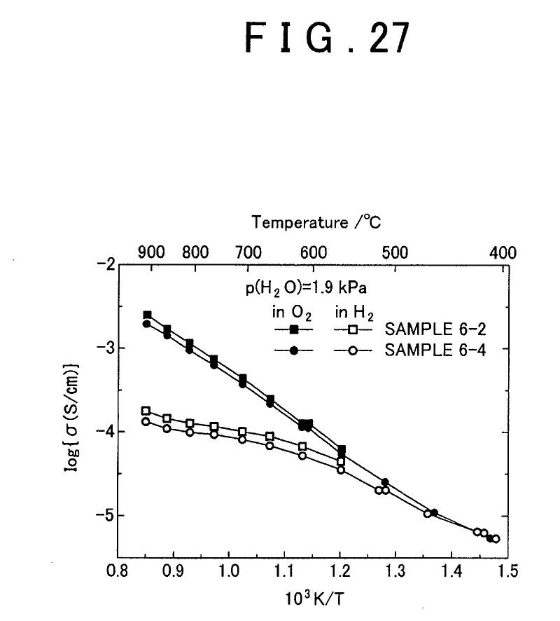

The electric conductivities of Samples 6-2 and 6-3 were measured. FIG. 27 shows the electric conductivities of Samples 6-2 and 6-7. In FIG. 27, the ordinate axis represents the logarithm of the electric conductivity (S/cm), and the abscissa axis represents the inverse number of the absolute temperature (1/K). In FIG. 27, hollow symbols show the electric conductivities of the samples in wet hydrogen, and solid symbols show the electric conductivities of the samples in wet oxygen. As shown in FIG. 27, each of Samples 6-2 and 6-4 exhibited good electric conductivity. It is estimated that each of the other samples in sixth example will exhibit good electric conductivity.

Analysis 11

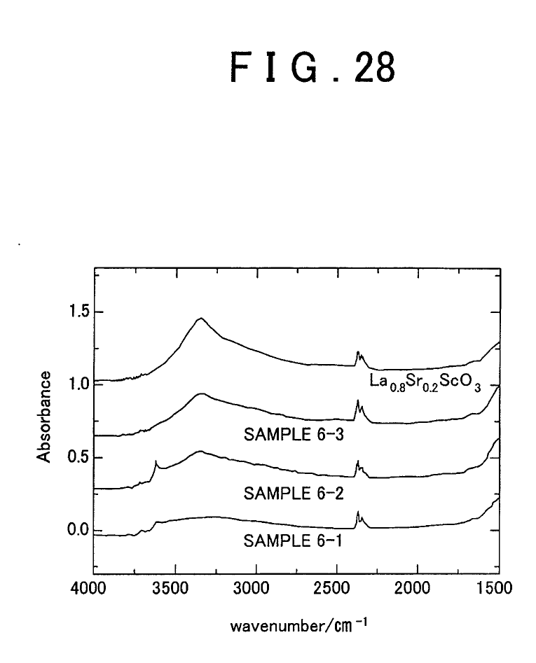

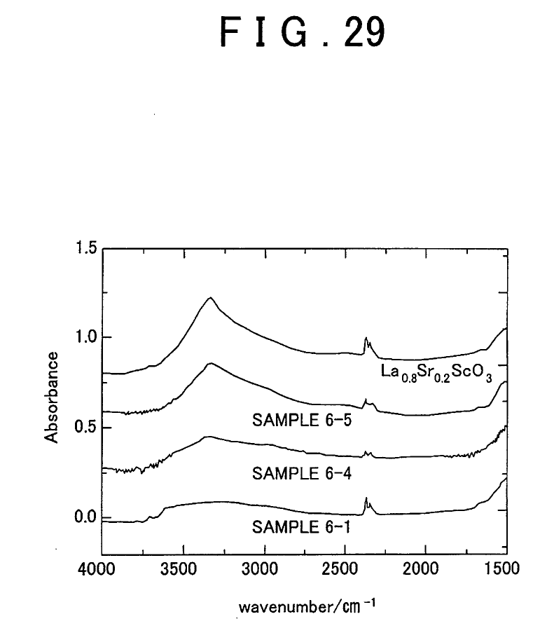

The infrared absorption spectrometry (IR) measurements were performed on Sample 6-1, 6-2, 6-3, 6-4, and 6-5. FIGS. 28 and 29 show the infrared absorption spectrometry (IR) patterns of Sample 6-1, 6-2, 6-3, 6-4, and 6-5. In each of FIGS. 28 and 29, the ordinate axis represents the absorbance, and the abscissa axis represents the wavelength. As shown in FIGS. 28 and 29, the absorption peak caused by OH stretching vibration was detected around 3300 cm⁻¹. Based on the results of the measurements, it is estimated that the protons serve as electric conducting elements in Samples 6-1, 6-2, 6-3, 6-4, and 6-5. Therefore, it turned out that Samples 6-1, 6-2, 6-3, 6-4, and 6-5 have good proton conductivity.

What is claimed is:

1. A proton conducting electrolyte having an ABO₃ type perovskite structure, comprising:
a Site-A; and
a Site-B that contains a first metal having a valence that is smaller than an average valence of the Site-B, and a second metal element having a valence that is larger than the average valence of the Site-B by at least one.

2. The proton conducting electrolyte according to claim 1, wherein the perovskite structure is indicated by La₍₁₋ₓ₎M1ₓM2_{(1-y)}M3_{y}O₃, the first metal element is M2, and the second metal element is M3.

3. The proton conducting electrolyte according to claim 1, wherein the first metal element is a bivalent metal, and the second metal element is a pentavalent metal.

4. The proton conducting electrolyte according to claim 2, wherein the first metal element is a bivalent metal, and the second metal element is a pentavalent metal.

5. The proton conducting electrolyte according to claim 2, wherein M1 is Strontium (Sr) or Barium (Ba), M2 is Magnesium (Mg) or Scandium (Sc), and M3 is Niobium (Nb) or Tantalum (Ta).

6. The proton conducting electrolyte according to claim 1,
wherein:
the proton conducting electrolyte is formed on an anode of an electrochemical cell; and
a cathode of the electrochemical cell is formed on the proton conducting electrolyte.

7. The proton conducting electrolyte according to claim 2,
wherein:
the proton conducting electrolyte is formed on an anode of an electrochemical cell; and
a cathode of the electrochemical cell is formed on the proton conducting electrolyte.

8. The proton conducting electrolyte according to claim 3,
wherein:
the proton conducting electrolyte is formed on an anode of an electrochemical cell; and
a cathode of the electrochemical cell is formed on the proton conducting electrolyte.

9. The proton conducting electrolyte according to claim 4,
wherein:
the proton conducting electrolyte is formed on an anode of an electrochemical cell; and
a cathode of the electrochemical cell is formed on the proton conducting electrolyte.

10. The proton conducting electrolyte according to claim 5,
wherein:
the proton conducting electrolyte is formed on an anode of an electrochemical cell; and
a cathode of the electrochemical cell is formed on the proton conducting electrolyte.

11. The proton conducting electrolyte according to claim 6, wherein the anode is a hydrogen separation membrane that has hydrogen permeability.

12. The proton conducting electrolyte according to claim 7, wherein the anode is a hydrogen separation membrane that has hydrogen permeability.

13. The proton conducting electrolyte according to claim 8, wherein the anode is a hydrogen separation membrane that has hydrogen permeability.

14. The proton conducting electrolyte according to claim 9, wherein the anode is a hydrogen separation membrane that has hydrogen permeability.

15. The proton conducting electrolyte according to claim 10, wherein the anode is a hydrogen separation membrane that has hydrogen permeability.

16. An electrochemical cell, comprising:
an anode;
the proton conducting electrolyte according to claim 1, which is formed on the anode; and
a cathode that is formed on the proton conducting electrolyte.

17. The electrochemical cell according to claim 16, wherein the anode is a hydrogen separation membrane that has hydrogen permeability.
